(19) United States
(12) Patent Application Publication
(10) Pub. No.: US 2017/0032125 A1
(43) Pub. Date: Feb. 2, 2017

(54) GLITCH DETECTOR, ELECTRONIC DEVICE HAVING THE SAME, AND ALARM SIGNAL GENERATION METHOD THEREOF

(71) Applicant: SAMSUNG ELECTRONICS CO., LTD., Suwon-si (KR)

(72) Inventors: Heonsoo LEE, Hwaseong-si (KR); Hyesoo LEE, Seongnam-si (KR); Yun-Ho YOUM, Seoul (KR)

(73) Assignee: SAMSUNG ELECTRONICS CO., LTD., Suwon-si (KR)

(21) Appl. No.: 15/198,636

(22) Filed: Jun. 30, 2016

(30) Foreign Application Priority Data
Jul. 30, 2015 (KR) 10-2015-0108166

(51) Int. Cl. G06F 21/57; G06F 1/24; G06F 21/77; G08B 21/18

(52) U.S. Cl. CPC G06F 21/57; G08B 21/18; G06F 1/24; G06F 21/77; G06F 2221/034

(57) ABSTRACT

A glitch detector, an electronic device including the glitch detector, and a method of generating an alarm signal are provided. The glitch detector includes a clock generator configured to generate a clock corresponding to a power voltage, a counter configured to count the clock generated by the clock generator and to output a count value, and a comparator configured to compare a reference value with the count value output by the counter and to generate an alarm signal based on a result of the comparison.

### CROSS-REFERENCE TO RELATED APPLICATIONS

This application claims priority from Korean Patent Application No. 10-2015-0108166 filed on Jul. 30, 2015, the entire contents of which are hereby incorporated by reference.

### BACKGROUND

Apparatuses and methods consistent with exemplary embodiments relate to a glitch detector, an electronic device having the same, and a method of generating an alarm signal.

A glitch attack technique is an attack that hacks a smart card by applying an abnormal signal to a power signal or an externally provided signal such that the smart card unpredictably operates. For example, a glitch is applied to an operating voltage for driving a chip in a smart card to steal data from an electrically erasable programmable read only memory (EEPROM). Accordingly, a smart card may include a glitch detector which detects a sudden increase or decrease in a voltage.

### SUMMARY

Exemplary embodiments provide a glitch detector, an electronic device including the glitch detector, and a method of generating an alarm signal.

According to an aspect of an exemplary embodiment, there is provided a glitch detector including a clock generator configured to generate a clock corresponding to a power voltage; a counter configured to count the clock generated by the clock generator and to output a count value; and a comparator configured to compare a reference value with the count value output by the counter and to generate an alarm signal based on a result of the comparison.

The clock generator may include a ring oscillator.

The counter may include a ripple counter.

The glitch detector may further include a synchronizer configured to synchronize the count value with a system clock that is different from the clock generated by the clock generator.

The count value output from the counter may be a binary code value, and the glitch detector may further include a binary gray code converter configured to convert the binary code value into a gray code value and to output the converted gray code value to the synchronizer, the synchronizer synchronizing the converted gray code value with the system clock, and a gray binary code converter configured to convert the synchronized gray code value into a binary code value and to output the converted binary code value to the comparator.

The glitch detector may further include a reference value generator configured to generate the reference value.

The reference value may be a fixed value.

The reference value may be a variable value.

The reference value may be a moving average value.

The comparator may generate the alarm signal when an absolute value of the count value minus the moving average value is greater than a threshold value.

The comparator may generate the alarm signal when the count value is greater than the moving average value, and the count value is greater than an upper limit, or the comparator may generate the alarm signal when the count value is not greater than the moving average value, and the count value is less than a lower limit.

The reference value may be a prior count value, wherein the comparator generates the alarm signal when an absolute value of the count value minus the prior count value is greater than a threshold value.

The comparator may generate the alarm signal when the count value is greater than an upper limit, or the comparator may generate the alarm signal when the count value is not greater than the upper limit, and the count value is less than a lower limit.

In a counting section of a system clock domain, the clock generator may generate the clock, and the counter may count the clock, and in a transferring section of the system clock domain, the clock generator may not generate the clock, and the counter may output the count value to the comparator.

According to an aspect of another exemplary embodiment, there is provided an electronic device including at least one central processing unit; and a glitch detector configured to generate a clock corresponding to a power voltage, to count the clock to generate a count value, to compare a reference value with the count value, to generate an alarm signal based on a result of the comparison, and to output the alarm signal to the at least one central processing unit.

The at least one central processing unit may perform a reset operation in response to the alarm signal.

The reference value may be generated in the glitch detector.

The reference value may be generated in the at least one central processing unit.

The reference value may include an upper limit and a lower limit, and wherein the at least one central processing unit changes the upper limit and the lower limit such that a sensitivity of the glitch detector is adjusted.

The glitch detector may be activated or deactivated according to a management policy of the electronic device.

According to an aspect of another exemplary embodiment, there is provided an alarm signal generating method of a glitch detector, the method including generating a clock corresponding to a power voltage; counting the clock to generate a count value; comparing a reference value with the count value; and generating an alarm signal based on the comparison result.

The comparing of the reference value may include determining whether an absolute value of the count value minus the reference value is greater than a threshold value; or determining whether the count value is greater than an upper limit; or determining whether the count value is smaller than a lower limit.

The reference value may be a moving average value, and the comparing of the reference value may include determining whether an absolute value of the count value minus the moving average value is greater than a threshold value.

The reference value may be a moving average value, and the comparing of the reference value may include determining whether the count value is greater than the moving average value; when the count value is greater than the moving average value, determining whether the count value is greater than an upper limit; and when the count value is not greater than the moving average value, determining whether the count value is less than a lower limit.

The generating of the alarm signal may include generating the alarm signal when the count value is greater than the upper limit or the count value is less than the lower limit.

The reference value may be a prior count value, and the comparing of the reference value may include determining whether an absolute value of the prior count value minus the count value is greater than a threshold value.

The method may further include synchronizing the count value with a system clock that is different than the clock that is generated, wherein the comparing of the reference value may include comparing the reference value with the synchronized count value.

The glitch detector may include a comparator configured to compare the reference value with the count value, and the method may further include transferring the count value to the comparator, wherein in a counting section of a system clock domain, the clock is generated, and the clock is counted, and wherein in a transferring section of the system clock domain, the count value is transferred to the comparator.

According to an aspect of an exemplary embodiment, there is provided a ring oscillator generating a first clock corresponding to a power voltage, the ring oscillator including a counter configured to count the first clock; and a comparator configured to compare a reference value with a count value output from the counter and to generate an alarm signal based on the comparison result, in response to a second clock that is different from the first clock.

According to an aspect of an exemplary embodiment, there is provided a glitch detector including a clock generator configured to generate a clock signal having a frequency that varies based on a power voltage driving the clock generator; and at least one processor configured to count the clock signal, and output an alarm when the count is outside a limit.

The limit may include an upper limit and a lower limit, and the count is outside the limit when the count exceeds the upper limit or drops below the lower limit.

The limit may be a variable limit.

The limit may be set by a device external to the glitch detector.

The at least one processor may operate according to a system clock that is different from the clock signal.

The at least one processor may count the clock signal in a first period of the system clock and output the alarm in a second period of the system clock that is different from the first period.

### BRIEF DESCRIPTION OF THE FIGURES

The above and other aspects will become apparent from the following description with reference to the following figures, wherein like reference numerals refer to like parts throughout the various figures unless otherwise specified, and wherein:

FIG. 1 is a block diagram exemplarily illustrating a glitch detector according to an exemplary embodiment;

FIG. 2 is a circuit diagram exemplarily illustrating a clock generator according to an exemplary embodiment;

FIG. 3 is a circuit diagram exemplarily illustrating a counter according to an exemplary embodiment;

FIG. 4 is a block diagram exemplarily illustrating a glitch detector according to another exemplary embodiment;

FIG. 5 is a block diagram exemplarily illustrating a glitch detector according to still another exemplary embodiment;

FIG. 6 is a block diagram exemplarily illustrating a glitch detector according to yet another exemplary embodiment;

FIG. 7 is a block diagram exemplarily illustrating a glitch detector according to yet another exemplary embodiment;

FIG. 8 is a block diagram exemplarily illustrating an electronic device in which an alarm signal is used as a reset signal, according to an exemplary embodiment;

FIG. 9 is a flow chart exemplarily illustrating a method of generating an alarm signal, of a glitch detector according to an exemplary embodiment;

FIG. 10 is a flow chart exemplarily illustrating a method of generating an alarm signal, of a glitch detector according to another exemplary embodiment;

FIG. 11 is a flow chart exemplarily illustrating a method of generating an alarm signal, of a glitch detector according to still another exemplary embodiment;

FIG. 12 is a flow chart exemplarily illustrating a method of generating an alarm signal, of a glitch detector according to yet another exemplary embodiment;

FIG. 13 is a flow chart exemplarily illustrating a method of generating an alarm signal, of a glitch detector according to yet another exemplary embodiment;

FIG. 14 is a flow chart exemplarily illustrating a method of generating an alarm signal, of a glitch detector according to yet another exemplary embodiment;

FIG. 15 is a flow chart exemplarily illustrating a method of generating an alarm signal, of a glitch detector according to yet another exemplary embodiment;

FIG. 16 is a block diagram exemplarily illustrating an electronic device according to an exemplary embodiment;

FIG. 17 is a block diagram exemplarily illustrating a mobile device according to an exemplary embodiment; and

FIG. 18 is a graph exemplarily illustrating an operating result of a glitch detector according to an exemplary embodiment.

### DETAILED DESCRIPTION

Exemplary embodiments will be described more fully hereinafter with reference to the accompanying drawings, in which certain exemplary embodiments are shown.

While the exemplary embodiments are susceptible to various modifications and alternative forms, specific exemplary embodiments thereof are shown by way of example in the drawings and will herein be described in detail. It should be understood, however, that there is no intent to limit the present disclosure to the particular forms disclosed, but on the contrary, the intention is to cover all modifications, equivalents, and alternatives falling within the spirit and scope of the inventive concept.

It will be understood that, although the terms “first,” “second,” “A,” “B,” etc. may be used herein in reference to elements, such elements should not be construed as being limited by these terms. For example, a “first” element could be termed a “second” element, and a “second” element could be termed a “first” element, without departing from the scope of the present disclosure.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe exemplary embodiments is not intended to limit the scope of the inventive concept. The articles “a,” “an,” and “the” are singular in that they have a single referent, however the use of the singular form in the present document should not preclude the presence of more than one referent. In other words, elements referred to as in singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which the present disclosure belongs. It will be further understood that terms in common usage should also be interpreted as is customary in the relevant art and not in an idealized or overly formal sense unless expressly so defined herein.

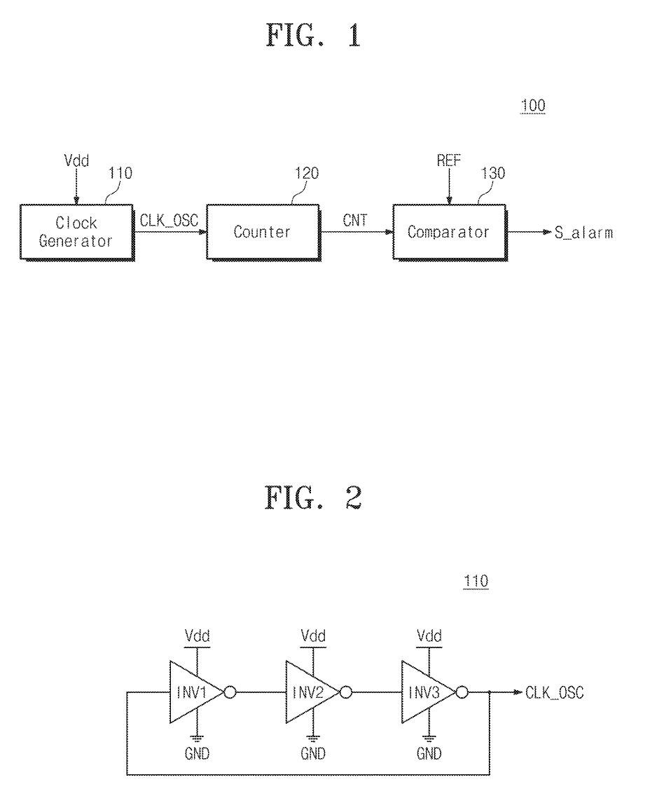

FIG. 1 is a block diagram exemplarily illustrating a glitch detector 100 according to an exemplary embodiment. Referring to FIG. 1, a glitch detector 100 may include a clock generator 110, a counter 120, and a comparator 130.

The clock generator 110 may be configured to receive a power voltage Vdd and to generate a clock CLK_OSC corresponding to the power voltage Vdd. For example, when the power voltage Vdd is relatively high, the clock CLK_OSC of a high frequency may be generated. When the power voltage Vdd is relatively low, the clock CLK_OSC of a low frequency may be generated. In some exemplary embodiments, the clock generator 110 may be a voltage controlled oscillator (VCO). For example, the clock generator 110 may be, but is not limited to, a ring oscillator, an LC oscillator, an LC VCO, or the like.

The counter 120 may be configured to count the clock CLK_OSC output from the clock generator 110 and output a count value CNT. In some exemplary embodiments, the counter 120 may be a synchronous or asynchronous counter. For example, the counter 120 may be, but is not limited to, a ripple counter, a BCD counter, a binary counter, a ring counter, a Johnson counter, or the like.

The comparator 130 may be configured to receive the count value CNT output from the counter 120, to compare a reference value REF with the count value CNT, and to generate an alarm signal S_alarm corresponding to the comparison result. For example, when a difference between the count value CNT and the reference value REF is large based on the comparison result, the alarm signal S_alarm may be generated. In an exemplary embodiment, when the difference between the count value CNT and the reference value REF is greater than or equal to a threshold value, the alarm signal S_alarm may be generated. The threshold value may be predetermined.

Generally, a glitch detector may be implemented with an analog circuit. The analog glitch detector may be configured such that characteristics of passive elements such as a resistor, a capacitor, and the like are tuned to be fit to a process, thereby reconfiguring the analog glitch detector whenever a new process is introduced. Moreover, because a size of a passive element such as a capacitor or the like is large, the passive element may occupy a large area. This would thus result in increased production costs for a semiconductor device. Moreover, because simple comparison is possible, it may be difficult to cope with a variety of glitches.

On the other hand, as illustrated in FIG. 1, the glitch detector 100 according to an exemplary embodiment may be implemented with digital circuits. Accordingly, a size of the glitch detector 100 may be smaller than that of the analog glitch detector and may be applied to various semiconductor processes without modification. Moreover, the glitch detector 100 may be usable in various operating environments through revising of software.

FIG. 2 is a circuit diagram exemplarily illustrating a clock generator 110 according to an exemplary embodiment. Referring to FIG. 2, a clock generator 110 may be, but is not limited to, a ring oscillator for outputting a clock CLK_OSC.

As illustrated in FIG. 2, the clock generator 110 may include three inverters INV1 to INV3 that are serially connected. Each of the three inverters INV1 to INV3 may be connected between the power voltage Vdd and a ground terminal GND, and an input terminal of the first inverter INV1 may be connected to an output terminal of the third inverter INV3. In FIG. 2, an exemplary embodiment is exemplified as the clock generator 110 includes three inverters INV1 to INV3. However, the scope and spirit of the inventive concept are not limited thereto. The clock generator 110 may be implemented with three or more inverters, the number of which is odd. In other words, the clock generator 110 is not particularly limited.

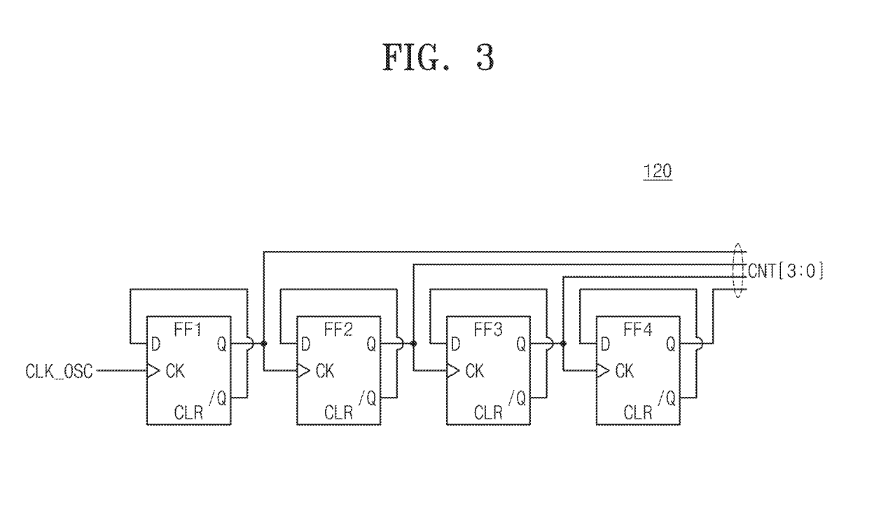

FIG. 3 is a circuit diagram exemplarily illustrating a counter 120 according to an exemplary embodiment. Referring to FIG. 3, the counter 120 may be implemented with a ripple counter.

As illustrated in FIG. 3, the counter 120 may include a ripple counter including four flip-flops FF1 to FF4. In each of the flip-flops FF1 to FF4, an input terminal D may be connected to an output terminal /Q; an output terminal Q of a front-stage flip-flop (e.g., the first flip-flop FF1) may be connected to a trigger input terminal CK of a next-stage flip-flop (e.g., the second flip-flop FF2). The clock CLK_OSC may be provided to a trigger input terminal CK of the first flip-flop FF1. A count value CNT[3:0] may be output from the output terminals Q of the first to fourth flip-flops FF1 to FF4. That is, a 4-bit count value may be output.

In FIG. 3, an exemplary embodiment is exemplified as the counter 120 includes four flip-flops FF1 to FF4. However, the scope and spirit of the inventive concept are not limited thereto. The counter 120 may be implemented with a plurality of flip-flops. In other words, the counter 120 is not particularly limited.

The glitch detector according to an exemplary embodiment may further include a synchronizer which synchronizes the count value CNT with a system clock.

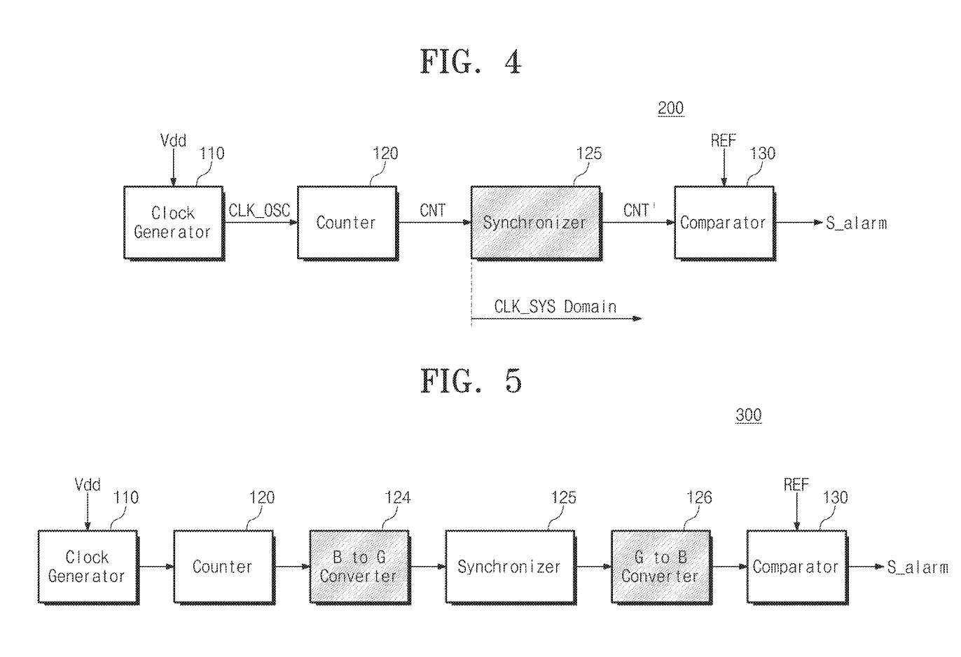

FIG. 4 is a block diagram exemplarily illustrating a glitch detector 200 according to another exemplary embodiment. Referring to FIG. 4, a glitch detector 200 may further include a synchronizer 125 connected between the counter 120 and the comparator 130, compared with the glitch detector 100 illustrated in FIG. 1.

The synchronizer 125 may be configured to receive a count value CNT output from the counter 120 and to output the count value CNT as a synchronized count value CNT′ synchronized with a system clock CLK_SYS. Thus, in the exemplary embodiment shown in FIG. 4, the comparator 130 may operate in the system clock (CLK_SYS) domain. The comparator 130 may compare a reference value REF with the synchronized count value CNT′ and may generate an alarm signal S_alarm corresponding to the comparison result.

The glitch detector according to an exemplary embodiment may convert the count value CNT into a gray code to reduce a glitch error caused in a counting operation.

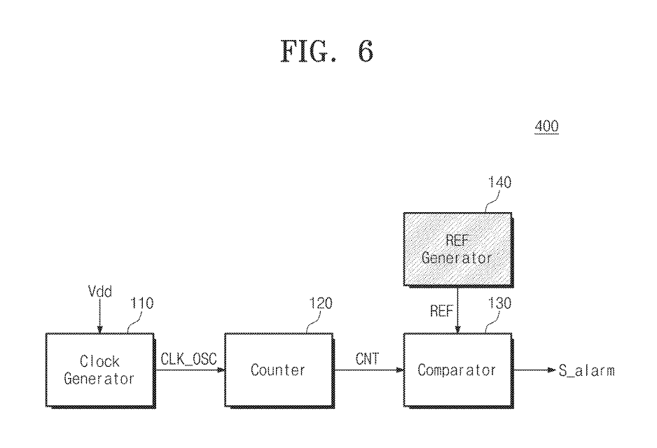

FIG. 5 is a block diagram exemplarily illustrating a glitch detector 300 according to still another exemplary embodiment. Referring to FIG. 5, a glitch detector 300 may further include a binary gray code converter (B to G Converter) 124 arranged in front of a synchronizer 125 and a gray binary code converter (G to B Converter) 126 arranged behind the synchronizer 125, compared with the glitch detector 200 illustrated in FIG. 4.

The binary gray code converter (B to G Converter) 124 may be configured to convert a count value CNT output from the counter 120 into a gray code value. Here, it is assumed that the count value CNT from the counter 120 is a binary code value.

The synchronizer 125 may synchronize the count value CNT, which is converted into a gray code, with a system clock CLK_OSC and may output the synchronized count value CNT′. Here, the synchronized count value may be a gray code value.

The gray binary code converter (G to B Converter) 126 may be configured to convert the gray code value output from the synchronizer 125 into a binary code value. The count value converted into a binary code value may be provided to the comparator 130.

The glitch detector 300 according to an exemplary embodiment may convert the count value CNT into a gray code that is changed for one bit and may synchronize the converted count value with a system clock, thereby reducing the probability that the count value CNT is recognized as another value.

The glitch detector according to an exemplary embodiment may further include a reference value generator which generates the reference value REF.

FIG. 6 is a block diagram exemplarily illustrating a glitch detector 400 according to yet another exemplary embodiment. Referring to FIG. 6, a glitch detector 400 may further include a reference value (REF) generator 140 generating the reference value REF, compared with the glitch detector 100 illustrated in FIG. 1. The reference value (REF) generator 140 may be configured to generate the reference value REF in hardware, firmware, or software.

In some exemplary embodiments, the reference value REF may be a fixed value or a variable value.

In some exemplary embodiments, the reference value (REF) generator 140 may be configured to receive information about a reference value from an external device and to generate the reference value REF corresponding to the received information about the reference value. Here, although not illustrated, the information about the reference value may be stored in registers of the reference value (REF) generator 140. Here, the reference value REF may be a binary code value.

In some exemplary embodiment, the reference value (REF) generator 140 may be configured to use various kinds of average values as the reference value REF. For example, a moving average value may be used as the reference value REF. In this case, the moving average value may be a real-time average value of the count value CNT and may be calculated as expressed by the following Equation 1.

$$Moving Average = \frac{127}{128} \times prior\_CNT + \frac{1}{128} \times CNT \qquad [ Equation 1 ]$$

In Equation 1, prior CNT may be a prior count value, and CNT may be a current count value. However, a moving average value calculating method according to an exemplary embodiment is not limited to Equation 1.

The reference value (REF) generator 140 is not limited to that disclosed herein. In FIG. 6, an exemplary embodiment is exemplified as the reference value (REF) generator 140 exists in the glitch detector 400; however, the scope and spirit of the inventive concept is not limited thereto. The reference value generator according to some exemplary embodiments may exist outside the glitch detector. Especially, the reference value generator may be implemented in a central processing unit (CPU) or a processor, which is outside the glitch detector, using firmware or software.

Although not illustrated, the reference value (REF) generator 140 may be added in the glitch detector 200 in FIG. 4 and the glitch detector 300 in FIG. 5.

As described above, the glitch detector according to an exemplary embodiment may efficiently use the system clock CLK_SYS without an independent synchronizer, thereby making it possible to synchronize the count value CNT.

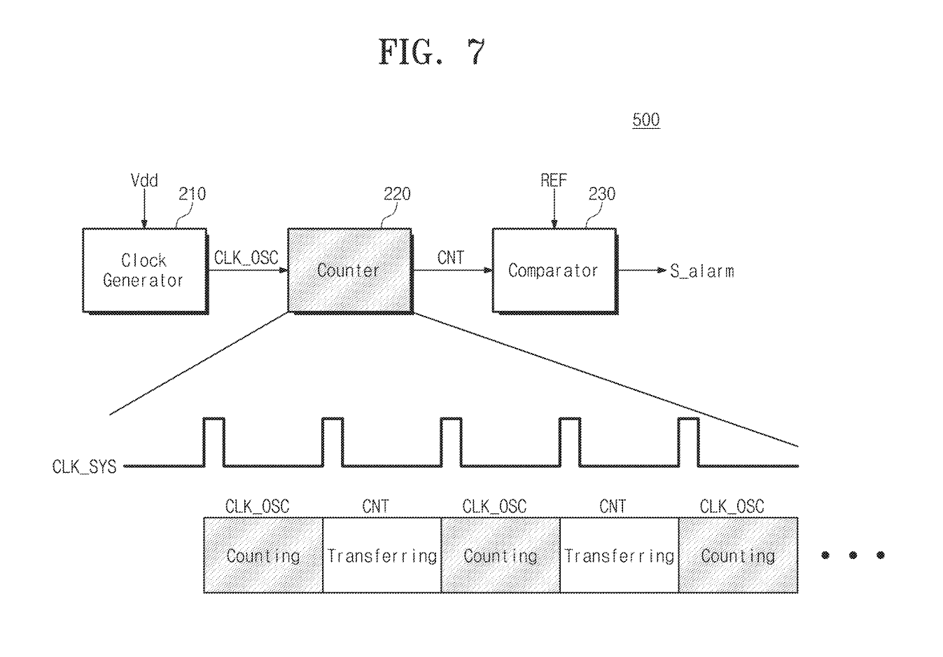

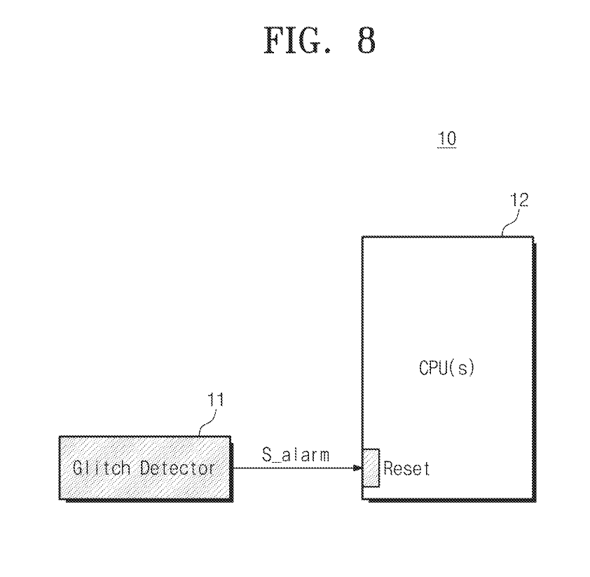

FIG. 7 is a block diagram exemplarily illustrating a glitch detector 500 according to yet another exemplary embodiment. Referring to FIG. 7, a glitch detector 500 may include a clock generator 210, a counter 220, and a comparator 230.

The clock generator 210 may be activated or deactivated in response to a system clock CLK_SYS (e.g., “a second clock”). That is, the clock generator 210 may generate a clock CLK_OSC (e.g., “a first clock”) in a counting section about the system clock CLK_SYS and may stop generating the clock CLK_OSC in a transferring section.

The counter 220 may be activated or deactivated in response to the system clock CLK_SYS. That is, in the counting section about the system clock CLK_SYS, the counter 220 may count the clock CLK_OSC. In the transferring section, the counter 220 may stop counting the clock CLK_OSC and may output a count value CNT.

In some exemplary embodiments, the counting section and the transferring section may repeat every cycle (or period) of the system clock CLK_SYS. The aforementioned repetition of the counting section and the transferring section is limited to that disclosed herein. As illustrated in FIG. 7, each of the counting section and the transferring section may correspond to one cycle. However, the scope and spirit of the inventive concept is not limited thereto. For example, lengths of the counting section and the transferring section may be set to be different from each other.

Additionally, a comparing section may be added. In another exemplary embodiment, the transferring section may include a comparing section. However, the counter 220 is not particularly limited.

The glitch detector 500 may further include the reference value (REF) generator 140 illustrated in FIG. 6.

FIG. 8 is a block diagram exemplarily illustrating an electronic device 10 in which an alarm signal S_alarm is used as a reset signal, according to an exemplary embodiment. Referring to FIG. 8, an electronic device 10 may include at least one glitch detector 11 and at least one CPU 12.

The at least one glitch detector 11 may be implemented with one of the glitch detector 100 illustrated in FIG. 1, the glitch detector 200 illustrated in FIG. 4, the glitch detector 300 illustrated in FIG. 5, the glitch detector 400 illustrated in FIG. 6, the glitch detector 500 illustrated in FIG. 7, or some combination thereof.

The at least one CPU 12 may be configured to perform a reset operation in response to the alarm signal S_alarm output from the at least one glitch detector 11. In an exemplary embodiment, a reset operation may be performed in response to one alarm signal S_alarm. In another exemplary embodiment, a reset operation may be performed in response to a plurality of alarm signals during a time. In other words, the reset operation may be performed in a situation in which a threshold number of alarms signals are received over a period of time. The threshold number and the period of time may each be predetermined, set at the factory, set experimentally, or set by the user. The aforementioned reset operation is not limited to that disclosed herein.

For example, the electronic device 10 may be one of the following devices or a combination of two or more thereof: a smartphone, a tablet personal computer (PC), a mobile phone, a video phone, an e-book reader, a desktop PC, a laptop PC, a netbook computer, a personal digital assistant (PDA), a portable multimedia player (PMP), a MP3 player, a mobile medical device, an electronic bracelet, an electronic necklace, an electronic appcessory, a camera, a wearable device, an electronic clock, a wrist watch, a home appliance (e.g., a refrigerator, an air conditioner, a vacuum cleaner, an oven, an microwave oven, a washing machine, an air cleaner, or the like), an artificial intelligence robot, a television (TV), a digital video disk (DVD) player, an audio system, various kinds of medical devices (e.g., a magnetic resonance angiography (MRA) camera, a magnetic resonance imaging (MRI) camera, a computed tomography (CT) camera, a ultrasonic machine, or the like), a navigation device, a global positioning system (GPS) receiver, an event data recorder (EDR), a flight data recorder (FDR), a set-top box, a TV box (e.g., Samsung HomeSync™, AppleTV™, or googleTV™), an electronic dictionary, a car infotainment device, an electronic equipment for ship (e.g., a navigation system for ship, a gyrocompass, or the like), an avionics system, a security device, electronic clothes, an electronic key, a camcorder, a game console, a head-mounted display (HMD), a flat panel display device, an electronic picture frame, an electronic album, furniture or a portion of a building or a structure, which is includes a communication function, an electronic board, an electronic signature receiving device, or a projector.

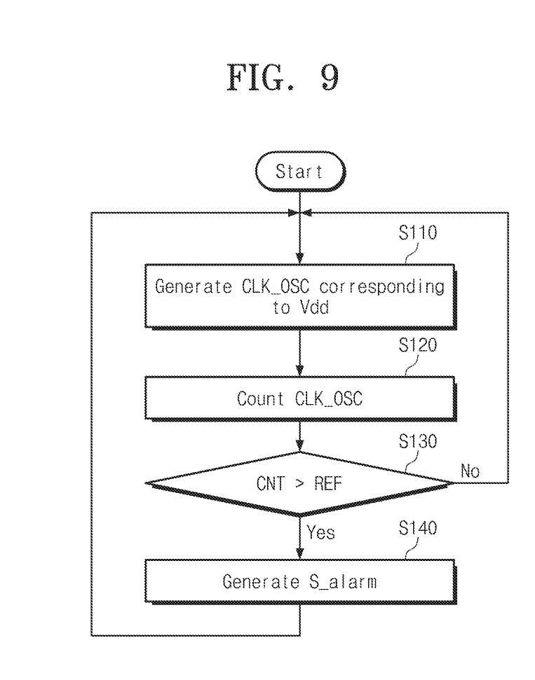

FIG. 9 is a flow chart exemplarily illustrating an alarm signal generating method of a glitch detector according to an exemplary embodiment. An alarm signal generating method of a glitch detector will be described with reference to FIGS. 1 and 9. However, it should be noted that the glitch detector of any of FIGS. 4-8 may also be used.

The clock generator 110 illustrated in FIG. 1 may generate the clock CLK_OSC corresponding to a power voltage Vdd (S110). The counter 120 illustrated in FIG. 1 may count the clock CLK_OSC output from the clock generator 110 (S120). The comparator 130 illustrated in FIG. 1 may determine whether a count value CNT is greater than or equal to a reference value REF (S130). The reference value REF may be a fixed value or a variable value. If the count value CNT is greater than or equal to the reference value REF, the alarm signal S_alarm may be generated (S140). On the other hand, if the count value CNT is not greater than or equal to the reference value REF, the method may proceed to operation S110.

According to the alarm signal generating method illustrated in FIG. 9, if the count value CNT is greater than the reference value REF, the alarm signal S_alarm may be generated. However, the inventive concept is not limited hereto. The alarm signal S_alarm may be generated even though the count value CNT is less than the reference value REF.

For the alarm signal generating method according to an exemplary embodiment, the alarm signal S_alarm may be generated using a moving average value as the reference value REF.

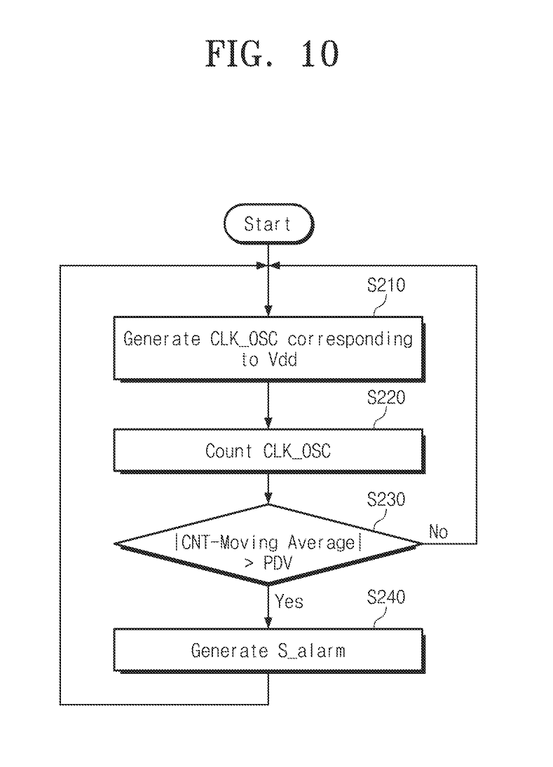

FIG. 10 is a flow chart exemplarily illustrating a method of generating an alarm signal, of a glitch detector according to another exemplary embodiment. Referring to FIG. 10, an alarm signal generating method of a glitch detector may be the same as that of FIG. 9 except operation S230. Operations S210 and S220 may be the same as operations S110 and S120 illustrated in FIG. 9, respectively. Accordingly, a detailed description about operations S210 and S220 is omitted. In operation S230, whether an absolute value of a count value CNT minus a moving average value is greater than a value PDV may be determined. The value PDV may be predetermined. If the absolute value of the count value CNT minus the moving average value is greater than the value PDV, the alarm signal S_alarm may be generated (S240).

In FIG. 10, determining whether the absolute value of the count value CNT minus the moving average value is greater than the value PDV or not may mean that both upper limit and lower limit of the count value CNT are identical. However, the scope and spirit of the inventive concept is not limited thereto. According to some exemplary embodiments, it may be possible to differently set the upper limit and the lower limit of the count value CNT.

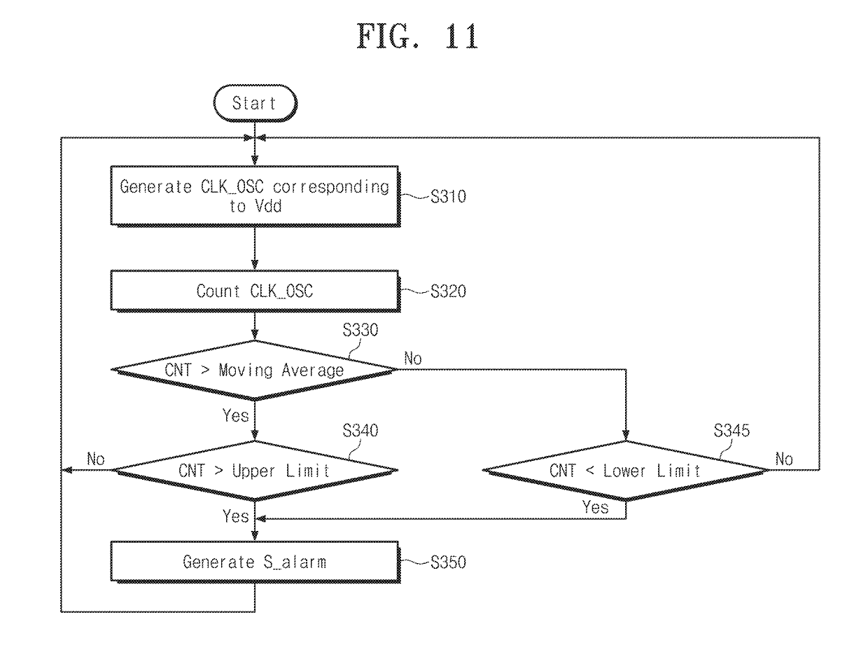

FIG. 11 is a flow chart exemplarily illustrating an alarm signal generating method of a glitch detector according to still another exemplary embodiment. Referring to FIG. 11, operations S310 and S320 may be the same as operations S110 and S120 illustrated in FIG. 9, respectively. Accordingly, a detailed description on operations S310 and S320 are omitted. In operation S330, whether a count value CNT is greater than a moving average value may be determined. If the count value CNT is greater than the moving average value (S330, YES), whether the count value CNT is greater than upper limit may be determined (S340). If the count value CNT is greater than the upper limit, the alarm signal S_alarm may be generated (S350). At this time, the alarm signal S_alarm may denote a positive glitch. Here, the upper limit may be set as a positive glitch determination reference by a user.

On the other hand, if the count value CNT is not greater than the moving average value (S330, NO), whether the count value CNT is less than lower limit may be determined (S345). If the count value CNT is less than the lower limit (S345, YES), the alarm signal S_alarm may be generated. Here, the alarm signal S_alarm may denote a negative glitch.

After the alarm signal S_alarm is generated in operation S350, the method may proceed to operation S310 to detect a glitch. Furthermore, if it is determined that the count value CNT is not greater than the upper limit in operation S340 (S340, NO) or if it is determined that the count value CNT is not less than the lower limit in operation S345 (S345, NO), the method may proceed to operation S310 to detect a glitch. Here, the lower limit may be properly set as a negative glitch determination reference by a user.

An alarm signal generating method of a glitch detector according to an exemplary embodiment may generate the alarm signal S_alarm as the reference value REF using a prior count value (prior CNT).

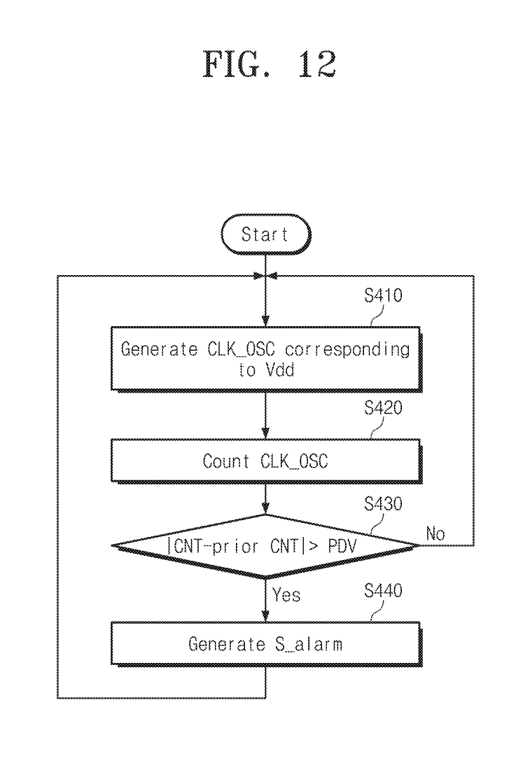

FIG. 12 is a flow chart exemplarily illustrating an alarm signal generating method of a glitch detector according to yet another exemplary embodiment. Referring to FIG. 12, operations S410 and S420 may be the same as operations S110 and S120 illustrated in FIG. 9, respectively. Accordingly, a detailed description on operations S410 and S420 will be omitted. In operation S430, whether an absolute value of a count value CNT minus a prior count value (prior CNT) is greater than a value PDV may be determined. Here, it is assumed that the prior count value (prior CNT) is stored in or out a glitch detector. If the absolute value of the count value CNT minus the prior count value (prior CNT) is greater than the value PDV, an alarm signal S_alarm may be generated (S440).

After the alarm signal S_alarm is generated in operation S440, the method may proceed to operation S410 to detect a glitch. Furthermore, if that the absolute value of the count value CNT minus the prior count value (prior CNT) is not greater than the value PDV is determined in operation S430 (S430, NO), the method may proceed to operation S410 to detect a glitch.

An alarm signal generating method of a glitch detector according to an exemplary embodiment may generate the alarm signal S_alarm using both upper limit and lower limit as the reference value (REF).

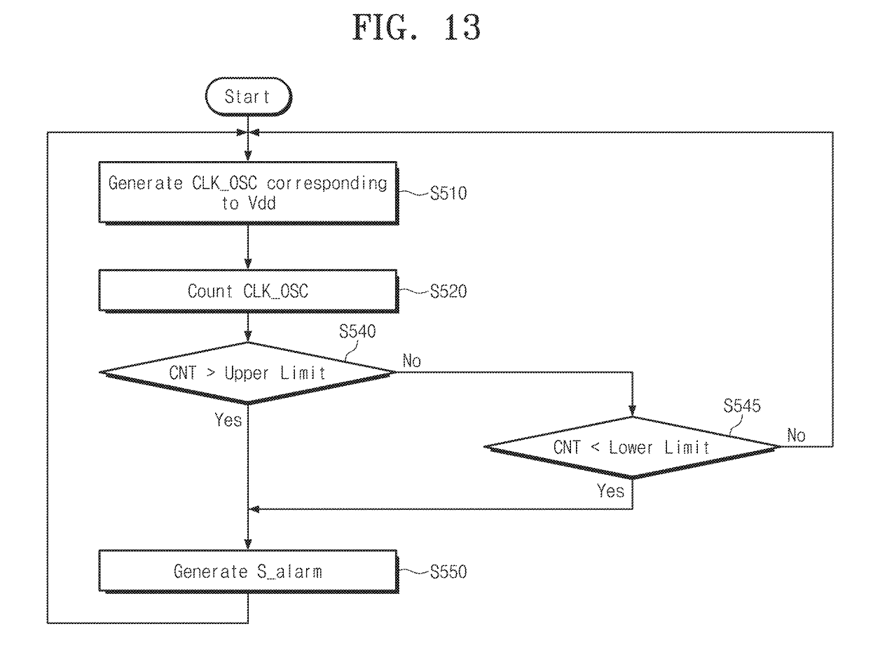

FIG. 13 is a flow chart exemplarily illustrating an alarm signal generating method of a glitch detector according to yet another exemplary embodiment. Referring to FIG. 13, operations S510 and S520 may be the same as operations S110 and S120 illustrated in FIG. 9, respectively. Accordingly, a detailed description of operations S510 and S520 will be omitted. In operation S540, whether a count value CNT is greater than an upper limit may be determined. If the count value CNT is greater than the upper limit (S540, YES), the alarm signal S_alarm which denotes a positive glitch may be generated (S550). On the other hand, if the count value CNT is not greater than the upper limit (S540, NO), whether the count value CNT is less than lower limit may be determined (S545). If the count value CNT is less than the lower limit (S545, YES), the alarm signal S_alarm which denotes a negative glitch may be generated (S550).

In FIG. 13, an exemplary embodiment is exemplified as operation S540 is performed before operation S545. However, the scope and spirit of the inventive concept is not limited thereto. For example, operation S545 may be performed before operation S540. The order of the above-described operations is not limited to that disclosed herein.

The alarm signal generating method according to an exemplary embodiment may further include synchronizing the count value CNT.

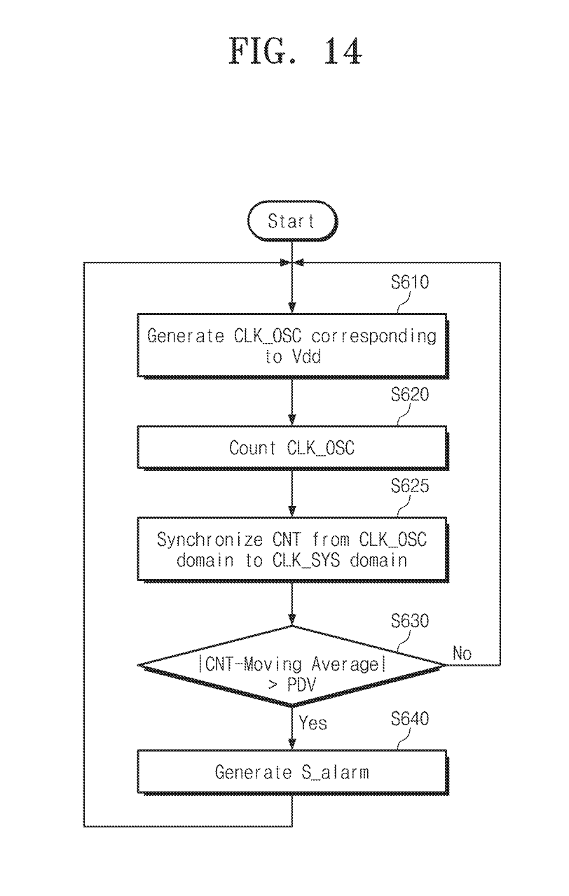

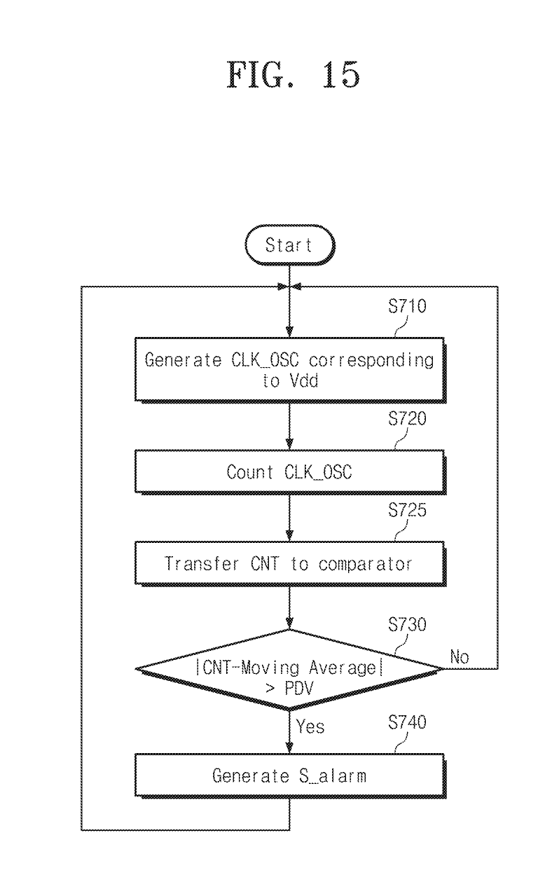

FIG. 14 is a flow chart exemplarily illustrating an alarm signal generating method of a glitch detector according to yet another exemplary embodiment. Referring to FIG. 14, an alarm signal generating method may further include operation S625, compared with that illustrated in FIG. 10. Operations S610, S620, S630, and S640 illustrated in FIG. 14 may be the same as operations S210, S220, S230, and S240 illustrated in FIG. 10, respectively. Accordingly, a detailed description of operations S610, S620, S630, and S640 will be omitted. In operation S625, a count value CNT may be synchronized in a system clock (CLK_SYS) domain, not the oscillator clock (CLK_OSC) domain. A synchronization operation of the count value CNT may be performed by the synchronizer 125 described with reference to FIG. 4.

According to an exemplary embodiment of the inventive concept, the count value CNT may be synchronized under the condition that the system clock domain is divided into a counting section and a transferring section (refer to FIG. 7).

FIG. 15 is a flow chart exemplarily illustrating an alarm signal generating method of a glitch detector according to yet another exemplary embodiment. Below, an alarm signal generating method will be described with reference to FIGS. 7 and 15.

In a counting section of a system clock (CLK_SYS) domain, the clock generator 210 illustrated in FIG. 7 may generate a clock CLK_OSC corresponding to a power voltage Vdd (S710). In a transferring section of the system clock domain, the counter 220 illustrated in FIG. 7 may count the clock CLK_OSC output from the clock generator 210 (S720). Next, in the transferring section of the system clock domain, the counter 220 may transfer a count value CNT to the comparator 230 illustrated in FIG. 7 (S725).

The comparator 230 may determine whether an absolute value of the count value CNT minus a moving average value is greater than a value PDV (S730). The value PDV may be predetermined. If the absolute value of the count value CNT minus the moving average value is greater than the value PDV (S730, YES), the alarm signal S_alarm may be generated (S740).

After the alarm signal S_alarm is generated in operation S740, the method may proceed to operation S710 to detect a glitch. Furthermore, if that the absolute value of the count value CNT minus a prior count value is not greater than the value PDV (S730, NO), the method may proceed to operation S710 to detect a glitch.

In FIG. 15, an exemplary embodiment is exemplified as the alarm signal S_alarm is generated when the absolute value of the count value CNT minus the moving average value is greater than the value PDV. However, the scope and spirit of the inventive concept is not limited thereto. For example, the alarm signal S_alarm may be generated when the absolute value of the count value CNT minus the moving average value is not greater than the value PDV.

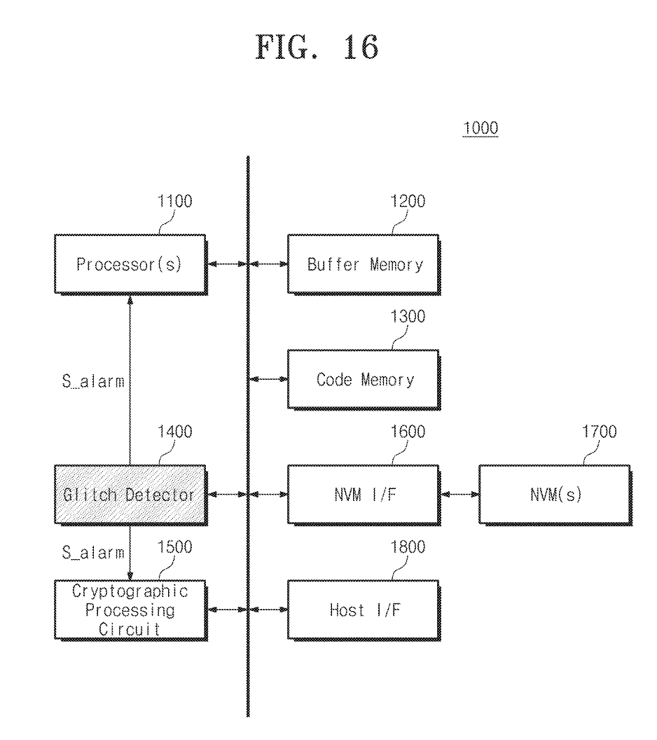

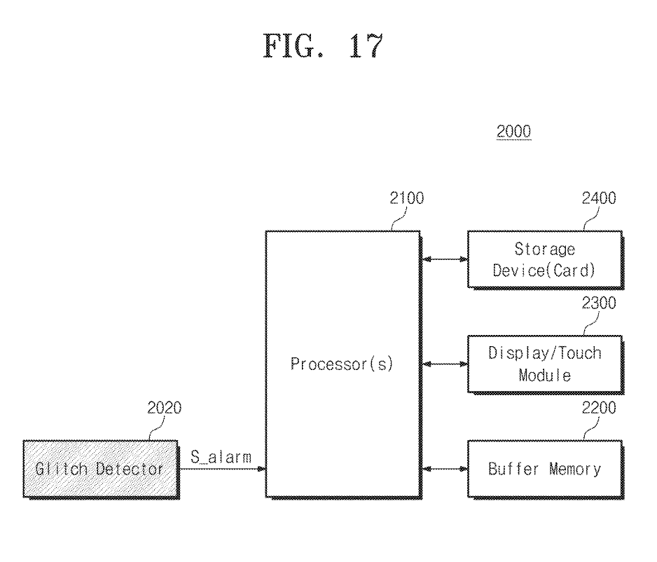

FIG. 16 is a block diagram exemplarily illustrating an electronic device 1000 according to an exemplary embodiment. Referring to FIG. 16, an electronic device 1000 may include at least one processor 1100, a buffer memory 1200, a code memory 1300, a glitch detector 1400, a cryptographic processing circuit 1500, a nonvolatile memory interface (NVM I/F) 1600, at least one nonvolatile memory device (NVM) 1700, and a host interface (Host I/F) 1800. The electronic device 1000 may be a data storage medium (e.g., a solid state drive (SSD), a memory stick, a universal flash storage (UFS) device), a memory card (e.g., a secure digital (SD) card, a multimedia card (MMC), an embedded multimedia card (eMMC), or the like), a smart card, a mobile device (e.g., a smartphone, Galaxy Tab™) , or the like.

The processor 1100 may be configured to control an overall operation about the electronic device 1000. In some exemplary embodiments, the processor 1100 may comprise one or more microprocessors. The processor 1100 may be configured to perform a specific operation (e.g., a reset operation, a circuit protection operation, a private information protection operation, or the like) in response to an alarm signal S_alarm.

In some exemplary embodiments, the processor 1100 may be a secure processor or a secure element (SE), and the like. For example, the processor 1100 may have a tamper-resistant function to allow the electronic device 1000 to be protected from a tempering attack such as a microprobing, a software attack, an eavesdropping, a fault generation, or the like.

The buffer memory 1200 may operate according to control of the processor 1100. For example, the buffer memory 1200 may temporarily store data to be processed by the processor 1100 or may buffer data to be transmitted to the nonvolatile memory device 1700 or data to be read from the nonvolatile memory device 1700. In some exemplary embodiments, the buffer memory 1200 may be a random access memory (RAM), a static random access memory (SRAM), and a phase-change random access memory (PRAM).

The code memory 1300 may be configured to store a code and/or an application for managing or operating the electronic device 1000. In some exemplary embodiments, the code memory 1300 may be a read only memory (ROM) or a PRAM.

The glitch detector 1400 may monitor a power voltage, may detect a glitch (e.g., a positive glitch or a negative glitch) of the power voltage, and may generate the alarm signal S_alarm corresponding to the detected glitch. The glitch detector 1400 may be implemented with the glitch detector 100, 200, 300, 400, or 500 and/or to perform an alarm signal generating method described with reference to FIGS. 1 to 15.

The cryptographic processing circuit 1500 may be configured to perform a cipher/decipher operation with respect to input/output data. The cryptographic processing circuit 1500 may be reset or deactivated in response to the alarm signal S_alarm. In FIG. 16, an exemplary embodiment is exemplified as the cryptographic processing circuit 1500 exists outside the processor 1100. However, the scope and spirit of the inventive concept is not limited thereto. For example, the cryptographic processing circuit 1500 may be implemented in the processor 1100.

Data exchange with the nonvolatile memory device 1700 may be performed through the NVM interface 1600. The nonvolatile memory device 1700 may be a NAND flash memory, a vertical NAND (VNAND) flash memory, a NOR flash memory, a resistive random access memory (RRAM), a phase-change memory (PRAM), a magnetoresistive random access memory (MRAM), a ferroelectronic random access memory (FRAM), a spin transfer torque random access memory (STT-RAM), or the like. The nonvolatile memory device 1700 may be implemented with a three-dimensional array structure.

The host interface 1800 may be connected to an external host through a parallel advanced technology attachment (PATA) bus, a serial advanced technology attachment (SATA) bus, a small computer system interface (SCSI), a universal serial bus (USB), a Peripheral Component Interconnect Express (PCIe), SD, a serial attached SCSI (SAS), a UFS, an eMMC, an MMC, a NAND interface, or the like.

Although not illustrated in FIG. 16, the electronic device 1000 may further include an error correction code (ECC) circuit. The ECC circuit may generate an ECC for correcting a fail bit or an error bit of data received from the nonvolatile memory device 1700, may perform error correction encoding with respect to the data provided to the nonvolatile memory device 1700, and may store data in which a parity bit is added. The parity bit may be stored in the nonvolatile memory device 1700. Moreover, The ECC circuit may perform error correction decoding with respect to data output from the nonvolatile memory device 1700. The ECC circuit may correct an error using a parity bit. The ECC circuit may correct an error using a coded modulation such as a low density parity check (LDPC) code, a Bose, Chaudhuri, Hocque-nghem (BCH) code, a turbo code, a Reed-Solomon code, a convolution code, a recursive systematic code (RSC), a trellis-coded modulation (TCM), a block coded modulation (BCM), or the like.

Although not illustrated, the electronic device 1000 may include a wireless communication function (e.g., WiFi). The electronic device 1000 may further include components that are not illustrated in FIG. 16 or may omit at least one (except a glitch detector) of components illustrated in FIG. 16.

FIG. 17 is a block diagram exemplarily illustrating a mobile device 2000 according to an exemplary embodiment. Referring to FIG. 17, a mobile device 2000 may include a glitch detector 2020, at least one processor 2100, a buffer memory 2200, a display/touch module 2300, and a storage device 2400.

The glitch detector 2020 may generate an alarm signal S_alarm based on the glitch detector 100, 200, 300, 400, or 500 and/or an alarm signal generating method thereof described with reference to FIGS. 1 to 15. In some exemplary embodiments, the glitch detector 2020 may be activated simultaneously when the mobile device 2000 is powered on. In other exemplary embodiments, the glitch detector 2020 may be activated or deactivated according to a request of a user or according to an internal management policy (e.g., a power consumption policy, an attack defense policy, or the like) of the mobile device 2000.

The processor 2100 may be configured to control an overall operation of the mobile device 2000 and a wired/wireless communication between the mobile device 2000 and an external device. For example, the processor 2100 may be an application processor (AP), an integrated modem application processor (hereinafter referred to as “ModAP”), a microprocessor or the like.

The buffer memory 2200 may be configured to temporarily store data, which is used when the mobile device 2000 performs a process operation. The display/touch module 2300 may be configured to display data processed from the processor 2100 or to receive data from a touch panel. The storage device 2400 may be configured to store data of a user. The storage device 2400 may be eMMC, SSD, UFS, or the like.

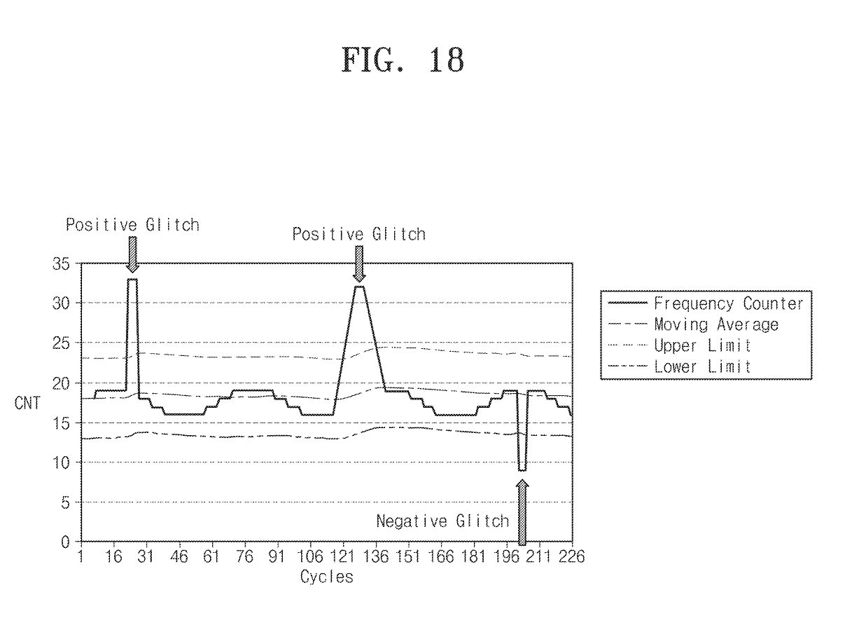

FIG. 18 is a graph exemplarily illustrating an operating result of a glitch detector according to an exemplary embodiment. Referring to FIG. 18, a glitch detector according to an exemplary embodiment may detect a positive glitch which varies suddenly high and a positive glitch which varies smoothly, as well as a negative glitch. Here, the positive glitch may denote the time when a moving average is greater than upper limit, and the negative glitch may denote the time when the moving average is smaller than lower limit.

In some exemplary embodiments, the upper limit and the lower limit may be fixed. In some exemplary embodiments, an external system may change the upper limit and/or the lower limit using software. That is, a sensitivity of a glitch detector may be adjustable.

According to exemplary embodiments, a glitch detector, an electronic device having the same, and an alarm signal generating method thereof may detect a glitch using digital circuits, thereby reducing the size of the glitch detector, comparing to an analog circuit, and making it possible to apply various semiconductor processes without modification.

Furthermore, according to exemplary embodiments, a glitch detector, an electronic device having the same, and an alarm signal generating method may change a reference value in various operating environments, thereby adjusting a sensitivity of the glitch detector.

While the inventive concept has been described with reference to exemplary embodiments, it will be apparent to those skilled in the art that various changes and modifications may be made without departing from the spirit and scope of the present inventive concept. Therefore, it should be understood that the above exemplary embodiments are not limiting, but illustrative.

1. A glitch detector comprising:
a clock generator configured to generate a clock corresponding to a power voltage;
a counter configured to count the clock generated by the clock generator and to output a count value; and
a comparator configured to compare a reference value with the count value output by the counter and to generate an alarm signal based on a result of the comparison.

2. The glitch detector of claim 1, wherein the clock generator comprises a ring oscillator.

3. The glitch detector of claim 1, wherein the counter comprises a ripple counter.

4. The glitch detector of claim 1, further comprising a synchronizer configured to synchronize the count value with a system clock that is different from the clock generated by the clock generator.

5. The glitch detector of claim 4, wherein the count value output by the counter is a binary code value,
the glitch detector further comprising:
a binary gray code converter configured to convert the binary code value into a gray code value and to output the converted gray code value to the synchronizer, the synchronizer being configured to synchronize the converted gray code value with the system clock, and
a gray binary code converter configured to convert the synchronized gray code value into a binary code value and to output the converted binary code value to the comparator.

6. The glitch detector of claim 1, further comprising a reference value generator configured to generate the reference value.

7. The glitch detector of claim 6, wherein the reference value is a fixed value.

8. The glitch detector of claim 6, wherein the reference value is a variable value.

9. The glitch detector of claim 8, wherein the reference value is a moving average value.

10. The glitch detector of claim 9, wherein the comparator is configured to generate the alarm signal when an absolute value of the count value minus the moving average value is greater than a threshold value.

11. The glitch detector of claim 9, wherein the comparator is configured to generate the alarm signal when the count value is greater than the moving average value, and the count value is greater than an upper limit, or
wherein the comparator is configured to generate the alarm signal when the count value is not greater than the moving average value, and the count value is less than a lower limit.

12. The glitch detector of claim 8, wherein the reference value is a prior count value, and
wherein the comparator is configured to generate the alarm signal when an absolute value of the count value minus the prior count value is greater than a threshold value.

13. The glitch detector of claim 8, wherein the comparator is configured to generate the alarm signal when the count value is greater than an upper limit, or
wherein the comparator is configured to generate the alarm signal when the count value is not greater than the upper limit, and the count value is less than a lower limit.

14. The glitch detector of claim 1, wherein the clock generator is configured to generate the clock in a counting section of a system clock domain, and to not generate the clock in a transferring section of the system clock domain, and
wherein the counter is configured to count the clock in the counting section of the system clock domain, and to output the count value to the comparator in the transferring section of the system clock domain.

15. An electronic device comprising:
at least one central processing unit; and
a glitch detector configured to generate a clock corresponding to a power voltage, to count the clock to generate a count value, to compare a reference value with the count value, to generate an alarm signal based on a result of the comparison, and to output the alarm signal to the at least one central processing unit,
wherein the at least one central processing unit is configured to perform a reset operation in response to the alarm signal.

16. The electronic device of claim 15, wherein the reference value comprises an upper limit and a lower limit.

17. The electronic device of claim 16, wherien the at least one central processing unit is configured to change the upper limit and the lower limit.

18. The electronic device of claim 15, wherein the glitch detector is configured to generate the alarm signal when an absolute value of the count value minus the moving average value is greater than a threshold value.

19. The electronic device of claim 15, wherein the glitch detector is configured to generate the alarm signal when the count value is greater than the moving average value, and the count value is greater than an upper limit, or
wherein the glitch detector is configured to generate the alarm signal when the count value is not greater than the moving average value, and the count value is less than a lower limit.

20-29. (canceled)

30. A glitch detector comprising:
a clock generator configured to generate a clock signal having a frequency that varies based on a power voltage driving the clock generator; and
at least one processor configured to count the clock signal, and to output an alarm when the count is outside a limit.

31-35. (canceled)
